(19) United States
(12) Patent Application Publication
(10) Pub. No.: US 2025/0076144 A1
(43) Pub. Date: Mar. 6, 2025

(54) PRESSURE GAUGE ZERO POINT CALIBRATION METHOD

(71) Applicant: SAMSUNG ELECTRONICS CO., LTD., Suwon-si (KR)

(72) Inventors: Seunghun KIM, Suwon-si (KR); Minjung KIM, Suwon-si (KR); Yujin HAN, Suwon-si (KR); Taemin KIM, Suwon-si (KR); Jiho UH, Suwon-si (KR); Jaesung YU, Suwon-si (KR); Jinseok LEE, Suwon-si (KR)

(73) Assignee: SAMSUNG ELECTRONICS CO., LTD., Suwon-si (KR)

(21) Appl. No.: 18/820,787

(22) Filed: Aug. 30, 2024

(30) Foreign Application Priority Data
Sep. 1, 2023 (KR) 10-2023-0116482
Nov. 10, 2023 (KR) 10-2023-0155715

(51) Int. Cl. G01L 27/00; G01L 9/00

(52) U.S. Cl. CPC G01L 27/002; G01L 9/0072

(57) ABSTRACT

A pressure gauge zero point calibration method of a pressure gauge having a diaphragm includes performing a first external zero point calibration at a first time, performing a second external zero point calibration at a second time, the second time occurring after the first time, generating a first usage during a first zero point interval, the first zero point interval spanning from the first time to the second time, determining a usage-based offset slope by dividing a zero point offset difference by the first usage, generating a second usage during a second zero point interval, the second zero point interval spanning from the second time to a third time, the third time occurring after the second time, obtaining a third zero point offset based on the usage-based offset slope and the second usage, and applying the third zero point offset to the pressure gauge, the pressure gauge having a diaphragm.

### CROSS-REFERENCE TO RELATED APPLICATIONS

This application claims benefit of priority under 35 U.S.C. § 119 to Korean Patent Application No. 10-2023-0116482, filed on Sep. 1, 2023, and Korean Patent Application No. 10-2023-0155715, filed on Nov. 10, 2023, in the Korean Intellectual Property Office, the disclosures of which are incorporated by reference herein in their entireties.

### BACKGROUND

### 1. Field

The present disclosure relates generally to a pressure gauge zero point calibration method, and more particularly, to a pressure gauge zero point calibration method for a pressure gauge including a diaphragm.

### 2. Description of Related Art

A capacitance pressure gauge, which may include a diaphragm and may have been subjected to a continuous use, may exhibit irreversible changes in the diaphragm over time and/or may have sediment layers adhering to the diaphragm. The capacitance pressure gauge may also be subject to periodic zero point calibration that may be performed externally by an operator.

However, for the zero point calibration of the capacitance pressure gauge, special conditions may need to be satisfied, such as, but not limited to, the operation of a pump and a valve to vacuum the space containing the pressure gauge before the zero point calibration is performed. Therefore, equipment subject to measurement by the pressure gauge may need to be stopped for a certain period of time while the zero point calibration of the pressure gauge is performed. When the zero point calibration of the pressure gauge needs to be performed frequently, productivity may be reduced due to the equipment stoppage. Alternatively or additionally, when zero point errors of the pressure gauge are neglected, zero point errors in measured pressure values of the pressure gauge may accumulate due to zero point errors of the equipment subject to measurement by the pressure gauge and/or inaccuracy of pressure measurement may increase, and as a result, reducing the measurement accuracy of the pressure gauge and/or the productivity of the equipment.

### SUMMARY

One or more example embodiments of the present disclosure provide zero point calibration considering usage of a pressure gauge to potentially increase the measurement reliability of the pressure gauge and potentially increase the reliability and/or productivity of equipment subject to measurement by the pressure gauge.

According to an aspect of the present disclosure, a pressure gauge zero point calibration method of a pressure gauge includes performing a first external zero point calibration at a first time, performing a second external zero point calibration at a second time, the second time occurring after the first time, generating a first usage during a first zero point interval, the first zero point interval spanning from the first time to the second time, determining a usage-based offset slope by dividing a zero point offset difference by the first usage, generating a second usage during a second zero point interval, the second zero point interval spanning from the second time to a third time, the third time occurring after the second time, obtaining a third zero point offset based on the usage-based offset slope and the second usage, and applying the third zero point offset to the pressure gauge. The pressure gauge having a diaphragm. The first usage includes a first area of a time versus differential pressure graph during the first zero point interval. The second usage includes a second area of the time versus differential pressure graph during the second zero point interval. The zero point offset difference is obtained by subtracting a first external zero point offset after completing the performing of the first external zero point calibration from a second external zero point offset prior to the performing of the second external zero point calibration.

According to an aspect of the present disclosure, a pressure gauge zero point calibration method of a pressure gauge includes performing a first external zero point calibration at a first time, performing a second external zero point calibration at a second time, the second time occurring after the first time, generating a first observation-based offset slope by dividing a first pressure difference between steps by a first elapsed time between the steps, determining a first estimated offset slope based on the first observation-based offset slope, obtaining a first observation offset based on the first estimated offset slope and the first elapsed time between the steps, and applying the first observation offset to the pressure gauge. The pressure gauge having a diaphragm. The first pressure difference between the steps is obtained by subtracting a first step pressure of a first vacuum step in which a zero point calibration is performed from a second step pressure of a second vacuum step in which the zero point calibration is not performed. The first elapsed time between the steps is a first time duration from the first vacuum step to the second vacuum step.

According to an aspect of the present disclosure, a pressure gauge zero point calibration method of a pressure gauge includes performing a first external zero point calibration at a first time, performing a second external zero point calibration at a second time, the second time occurring after the first time, generating a first usage during a first zero point interval, the first zero point interval spanning from the first time to the second time, determining a usage-based offset slope by dividing a zero point offset difference by the first usage, generating a second usage during a second zero point interval, the second zero point interval spanning from the second time to a third time, the third time occurring after the second time, determining a third zero point offset based on the usage-based offset slope and the second usage, applying the third zero point offset to the pressure gauge, the pressure gauge having a diaphragm, obtaining a first observation-based offset slope by dividing a first pressure difference between steps by a first elapsed time between the steps, generating a first estimated offset slope based on the first observation-based offset slope, generating a first observation offset based on the first estimated offset slope and the first elapsed time between the steps, applying the first observation offset to the pressure gauge, generating a second observation-based offset slope by dividing a second pressure difference between the steps by a second elapsed time between the steps, generating a second estimated offset slope based on the first estimated offset slope and the second observation-based offset slope, generating a second observation offset based on the second estimated offset slope and the second elapsed time between the steps, applying the second observation offset to the pressure gauge, generating a third usage during a third zero point interval, the third zero point interval spanning from the third time to a fourth time, and generating a fourth zero point offset based on the usage-based offset slope and the third usage. The first usage includes a first area of a time versus differential pressure graph exceeding a first reference differential pressure during the first zero point interval. The second usage includes a second area of the time versus differential pressure graph exceeding the first reference differential pressure during the second zero point interval. The third usage includes a third area of the time versus differential pressure graph exceeding the first reference differential pressure during the third zero point interval. The zero point offset difference is obtained by subtracting a first external zero point offset of the first external zero point calibration from a second external zero point offset of the second external zero point calibration. The third zero point offset is obtained by multiplying the usage-based offset slope by the second usage. The fourth zero point offset is obtained by multiplying the usage-based offset slope by the third usage. The first pressure difference between the steps is obtained by subtracting a first step pressure of a first vacuum step in which a zero point calibration is performed from a second step pressure of a second vacuum step in which the zero point calibration is not performed. The second pressure difference between the steps is obtained by subtracting a third step pressure of a third vacuum step in which the zero point calibration is performed from a fourth step pressure of a fourth vacuum step in which the zero point calibration is not performed. The first elapsed time between the steps is a first time duration from the first vacuum step to the second vacuum step. The second elapsed time between the steps is a second time duration from the second vacuum step to the third vacuum step. The second zero point interval and the third zero point interval have a range between 1 day and 120 days. The first elapsed time between the steps and the second elapsed time between the steps have a range between 1 minute and 60 minutes. The first reference differential pressure has a range between 5 Pascals per second (Pa/s) and 20 Pa/s.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIGS. 1A and 1B are cross-sectional views of pressure gauges to which a pressure gauge zero point calibration method is applied, according to an embodiment;

FIG. 2 is a flowchart of a pressure gauge zero point calibration method, according to an embodiment;

FIG. 3 is a graph for describing a pressure gauge zero point calibration method, according to an embodiment;

FIGS. 4A and 4B are graphs for describing the usage of a pressure gauge in a pressure gauge zero point calibration method, according to an embodiment; and

FIGS. 5 and 6 are graphs showing zero point errors depending on whether a pressure gauge zero point calibration method is applied, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any possible combination of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

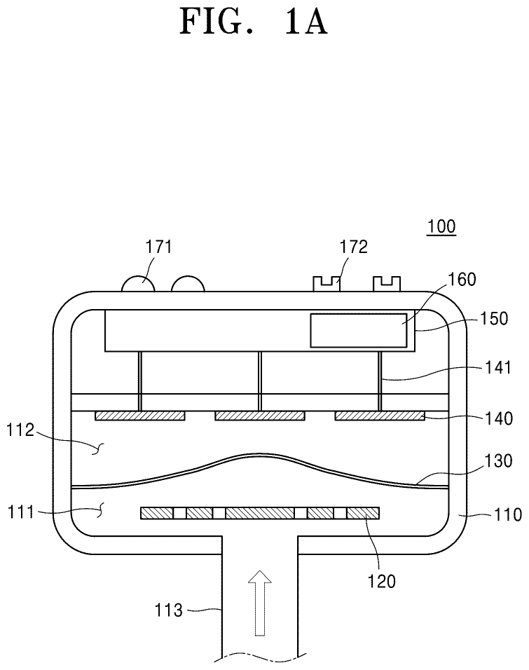

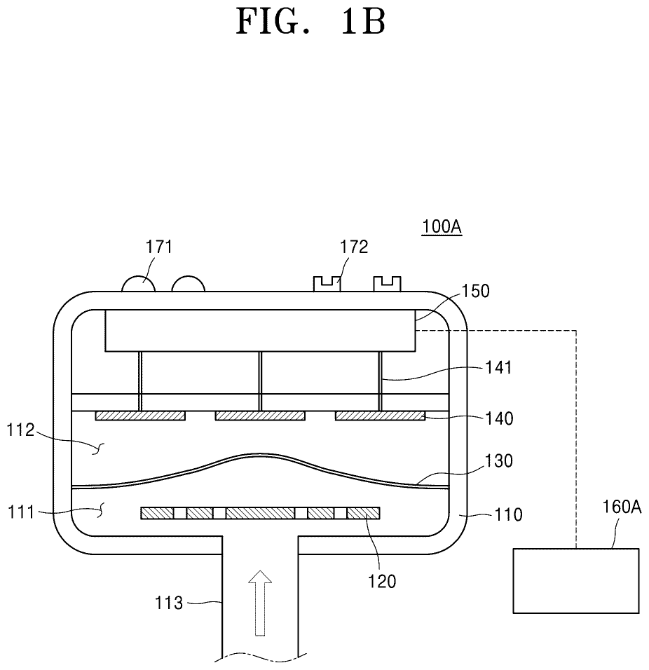

FIGS. 1A and 1B are cross-sectional views of pressure gauges to which a pressure gauge zero point calibration method is applied, according to an embodiment.

Referring to FIGS. 1A and 1B, the pressure gauges 100 and 100A, respectively, may include a housing 110, a diaphragm 130 placed within the housing 110, a baffle 120, an electrode 140 placed on a support portion, wiring 141, an electronic board 150, a zero point controller 160 included in an electronic circuit, an operating lamp 171, and an external zero point calibration button 172.

The space inside the housing 110 may be divided into a first space 111 and a second space 112 by the diaphragm 130. Fluid from a conduit 113 connected to equipment subject to pressure measurement by the pressure gauges 100 or 100A may be input and may apply pressure to the first space 111. The second space 112 may be provided with a gas at a reference pressure and/or may be a vacuum. The reference pressure of the second space 112 may be, for example, atmospheric pressure. Due to the pressure of the fluid applied through the first space 111, the diaphragm 130 may be bent toward the second space 112. The diaphragm 130 may be bent due to a force caused by the difference in pressure between the fluid in the first space 111 and the fluid (e.g., gas) in the second space 112. The diaphragm 130 may be configured to be deformed by an external force. For example, the planar shape of the diaphragm 130 may be circular or square. However, the present disclosure is not limited thereto, and the diaphragm 130 may have other various shapes.

The electrode 140 may be provided with the support portion on one side of the electrode 140 and may remain fixed to the support portion regardless of pressure. The electrode 140 may have, for example, a concentric circle shape. However, the present disclosure is not limited thereto, and the electrode 140 may have other various shapes.

An insulator may be provided between the electrode 140 and the support portion. In an embodiment, the electrode 140 and the diaphragm 130 may function as a capacitor. For example, the pressure applied to the first space 111 may be measured through a difference in a capacitance of the electrode 140 when no pressure is applied to the diaphragm 130 (and the diaphragm 130 and the electrode 140 are a preset distance apart) and a capacitance of the electrode 140 when the diaphragm 130 is in a deformed state due to the pressure applied to the first space 111 (and the diaphragm 130 and the electrode 140 are a different distance apart). That is, as the pressure of the fluid supplied to the diaphragm 130 through the conduit 113 increases, the diaphragm 130 may be more greatly deformed. When the diaphragm 130 is greatly deformed, a capacitance value between the diaphragm 130 and the electrode 140 may change accordingly. In an embodiment, the pressure applied to the first space 111 may be measured through changes in the capacitance value of the electrode 140.

The pressure gauges 100 and 100A may include the electronic board 150. The electronic board 150 may be electrically connected to the electrode 140 through the wiring 141. The electronic board 150 may receive an electrical signal from the wiring 141 and may measure the capacitance value of the electrode 140 using the electrical signal from the wiring 141. The electronic board 150 may generate pressure values from the measured capacitance value. The electronic board 150 may output and/or store the pressure values over time.

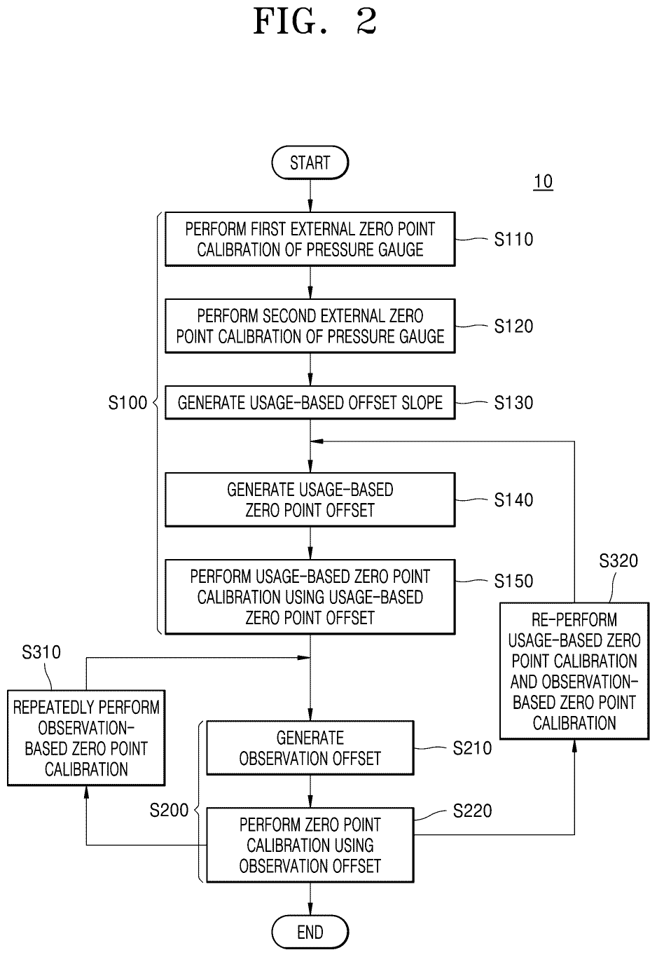

As shown in FIG. 1A, the electronic board 150 may include the zero point controller 160. The zero point controller 160 may be part of the electronic board 150. Alternatively, as shown in FIG. 1B, a zero point controller 160A may be separately provided outside the electronic board 150 and may be electrically connected to the electronic board 150. The pressure gauge zero point calibration method, according to an embodiment, may be performed by the zero point controllers 160 and 160A. Alternatively or additionally, the pressure gauge zero point calibration method may be performed by the electronic board 150 including the zero point controller 160. The pressure gauge zero point calibration method is described with reference to FIG. 2.

The zero point controllers 160 and 160A may be implemented in hardware, firmware, and/or a combination of hardware and software. For example, the zero point controllers 160 and 160A may be and/or may include a central processing unit (CPU), an application processor (AP), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip and/or multi-chip processor, or other programmable logic device, discrete gate or transistor logic, discrete hardware components, or any combination thereof designed to perform the functions described herein, such as, but not limited to, the pressure gauge zero point calibration method.

In an embodiment, the electronic board 150, in conjunction with the zero point controllers 160 and/or 160A, may perform the functions described herein by executing computer-readable instructions and/or code that may be stored and/or accessed by the electronic board 150. For example, the computer-readable instructions and/or code may be stored by a non-transitory computer-readable medium, such as a non-transitory memory device that may include a memory space within a single physical storage device and/or a memory space spread across multiple physical storage devices.

FIG. 2 is a flowchart of the pressure gauge zero point calibration method, according to an embodiment.

Referring to FIG. 2, the pressure gauge zero point calibration method 10, according to an embodiment, may include performing a first external zero point calibration of a pressure gauge (operation S110), performing a second external zero point calibration of the pressure gauge (operation S120), generating a usage-based offset slope (operation S130), generating a usage-based zero point offset (operation S140), performing usage-based zero point calibration of the pressure gauge using the usage-based zero point offset (operation S150), generating an observation offset (operation S210) and performing observation-based zero point calibration using the observation offset (operation S220).

In addition, the pressure gauge zero point calibration method 10, according to an embodiment, may include repeatedly performing observation-based zero point calibration (operation S310) after the performing of the observation-based zero point calibration using the observation offset (operation S220) and re-performing usage-based zero point calibration and observation-based zero point calibration (operation S320) after the performing of the observation-based zero point calibration using the observation offset (operation S220).

In operation S310 of repeatedly performing observation-based zero point calibration, the generating of the observation offset (operation S210) may be performed again after the performing of the observation-based zero point calibration using the observation offset (operation S220). In operation S320 of re-performing the usage-based zero point calibration and the observation-based zero point calibration, the generating of the usage-based offset slope (operation S130) and the generating of the usage-based zero point offset (operation S140) may be performed after the performing of the observation-based zero point calibration using the observation offset (operation S220).

The pressure gauge zero point calibration method 10, according to an embodiment, may include usage-based zero point calibration (operation S100) and observation-based zero point calibration (operation S200). The usage-based zero point calibration (operation S100) may include performing the first external zero point calibration of the pressure gauge (operation S110), performing the second external zero point calibration of the pressure gauge (operation S120), generating the usage-based offset slope (operation S130), generating the usage-based zero point offset (operation S140), and performing the usage-based zero point calibration of the pressure gauge using the usage-based zero point offset (operation S150). The observation-based zero point calibration (operation S200) may include generating the observation offset (operation S210) and performing the observation-based zero point calibration using the observation offset (operation S220).

However, a usage-based zero point calibration performed after the first usage-based zero point calibration may include generating the usage-based zero point offset (operation S140), and performing the usage-based zero point calibration of the pressure gauge using the usage-based zero point offset (operation S150).

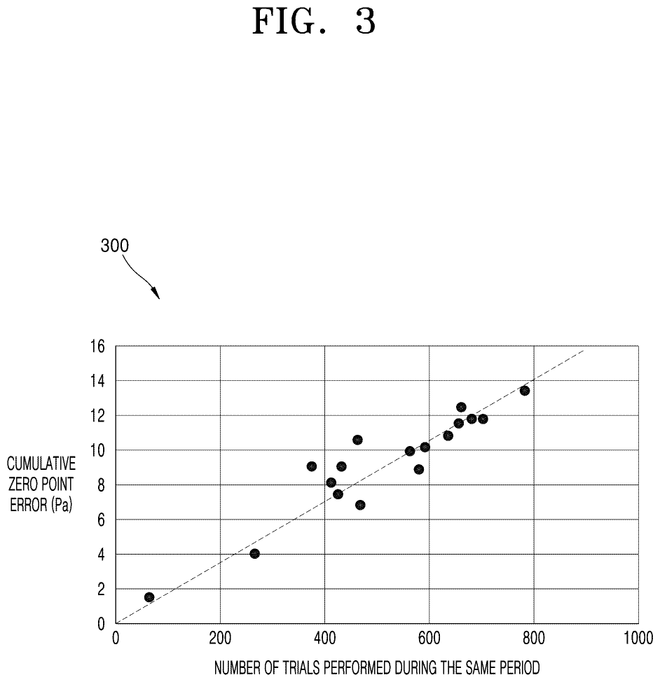

FIG. 3 illustrates a graph 300 for describing the pressure gauge zero point calibration method 10, according to an embodiment.

Referring to FIG. 3, in the pressure gauge zero point calibration method 10, the usage-based zero point calibration (operation S100) may include quantifying the usage level of the pressure gauge to be used as a coefficient for zero point calibration. The pressure gauge 100, including the diaphragm 130, may measure relatively low pressure and/or relatively high pressure. Alternatively or additionally, the pressure may be measured for a relatively long time and/or the pressure may be measured for a relatively short time.

When the usage of a pressure gauge is simply generated based on the operating time of the pressure gauge, it may be difficult to simultaneously consider the magnitude of the pressure measured by the pressure gauge as described above and the variables depending on the operating time of the pressure gauge for measuring the pressure.

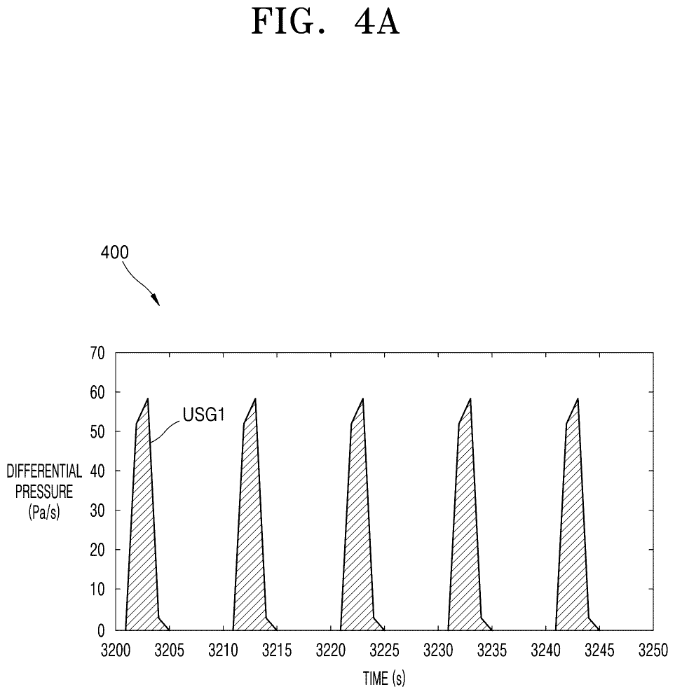

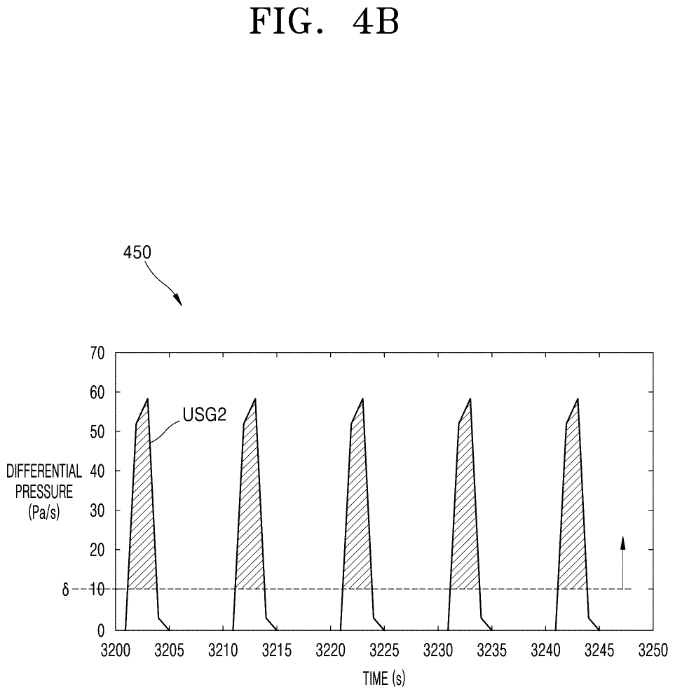

The horizontal axis of the graph 300 of FIG. 3 represents the number of times a process is performed by the equipment where the pressure gauge is installed during the same period. For example, the horizontal axis may represent the number of times a semiconductor process is performed in the equipment where the pressure gauge is installed for 100 days. The vertical axis of the graph 300 of FIG. 3 represents a cumulative zero point error value over that same period (e.g., 100 days). The graph 300 of FIG. 3 shows a generally linearly proportional relationship between the horizontal and vertical axes. For example, a correlation coefficient between the horizontal and vertical axes of the graph 300 of FIG. 3 may be calculated to be about 0.94, and as such, the number of trials performed during the same period may be proportional to the cumulative zero point error value. That is, the usage of the pressure gauge may be proportional to the cumulative zero point error value. A method of generating the usage of the pressure gauge, which may refer to the degree to which the pressure gauge is used, is described with reference to FIGS. 4A and 4B.

FIGS. 4A and 4B are graphs for describing the usage of a pressure gauge in the pressure gauge zero point calibration method 10, according to an embodiment.

FIG. 4A is a graph 400 showing differential pressure of a measured pressure value over time of the pressure gauge. According to the graph 400 of FIG. 4A, a differential pressure of up to 60 Pascals per second (Pa/s) may be measured for about 4 seconds, and a differential pressure may not be subsequently measured for about 6 seconds. The usage of the pressure gauge may refer to an area of the time versus differential pressure graph 400.

In the pressure gauge zero point calibration method 10, according to an embodiment, the usage-based zero point calibration (operation S100) may include performing the first external zero point calibration of the pressure gauge (operation S110) and performing the second external zero point calibration of the pressure gauge (operation S120). The first external zero point calibration and the second external zero point calibration may refer to zero point calibrations performed after stopping the equipment by a user or an operator. That is, the first external zero point calibration and the second external zero point calibration may not refer to zero point calibrations performed by the pressure gauge itself.

The time at which the first external zero point calibration is performed may be referred to as a first time, and the time at which the second external zero point calibration is performed may be referred to as a second time. The time interval from the first time to the second time may be referred to as a first zero point interval. The first zero point interval may be between about 1 day and about 120 days. The first zero point interval may refer to a period in which an external zero point calibration is performed. For example, the time interval between the first time and the second time may be 4 weeks or 1 month. However, the present disclosure is not limited in this regard.

A portion of the differential pressure, which may refer to a differential value of the measured pressure during the first zero point interval, may be shown in the graph 400 of FIG. 4A. That is, the vertical axis of the graph 400 of FIG. 4A and the graph 450 of FIG. 4B may refer to differential pressures obtained by differentiating the pressure value measured through the pressure gauge (e.g., the pressure gauge 100 or 100A) over time.

However, measurement and storage of the pressure value may be done discontinuously, that is, discretely. Consequently, the differential pressure herein may be a pressure value generated by discrete differentiation. For example, when the measurement and storage of the pressure value by the pressure gauge (e.g., the pressure gauge 100 or 100A) continues in 0.1 second increments, the differential pressure as shown in FIGS. 4A and 4B may be generated by continuously generating the pressure value that changes for 0.1 seconds divided by 0.1 seconds.

During pressure measurement by the pressure gauge (e.g., the pressure gauge 100 or 100A), positive and negative differential pressure values may be generated. That is, when the measured pressure of the pressure gauge (e.g., the pressure gauge 100 or 100A) increases, the differential pressure value may appear as a positive number, and/or when the measured pressure decreases, the differential pressure value may appear as a negative number. When the differential pressure value is a negative number, a usage value may be generated by using the differential pressure value obtained by changing the negative number to a positive number. FIGS. 4A and 4B may be graphs showing the differential pressure after the negative differential pressure value is taken as an absolute value and changed to a positive number.

The first usage during the first zero point interval, which may refer to the time interval from the first time to the second time, may be generated. That is, the first usage may be generated by cumulatively calculating the usage USG1, which is an area of the time versus differential pressure graph 400 as shown in FIG. 4A during the first zero point interval. That is, the first usage may be generated by integrating the time versus differential pressure graph 400 during the first zero point interval. In an embodiment, the usage may be expressed in units of pressure (e.g., Pa).

FIG. 4B is a graph showing the differential pressure of the measured pressure value over time of the pressure gauge. In FIG. 4B, the first usage may refer to a first usage during the first zero point interval, which may refer to a time interval from the first time to the second time, and unlike FIG. 4A, the usage may be generated for the measured pressure value exceeding a first reference differential pressure 6.

That is, in the time versus differential pressure graph 450 shown in FIG. 4B, during the first zero point interval, the first usage may be generated by calculating an area of the graph where the differential pressure value exceeds the first reference differential pressure 6. In other words, in the time versus differential pressure graph 450 during the first zero point interval, the first usage may be generated by integrating the area of the graph where the differential pressure exceeds the first reference differential pressure 6. In an embodiment, the usage may be expressed in units of pressure/time (e.g., Pa/s).

The usage USG2 in FIG. 4B where the first reference differential pressure 6 is set may indicate that the usage may be generated by removing a portion thereof where the change in pressure is low and/or by removing a portion thereof where the differential pressure is low in a range in which irreversible changes in the diaphragm 130 provided in the pressure gauge (e.g., pressure gauge 100 or 100A) do not occur over time. Alternatively or additionally, the first reference differential pressure 6 may be set to reduce the influence of the measured pressure value caused by an error in the pressure gauge (e.g., pressure gauge 100 or 100A).

For example, the first reference differential pressure 6 may have a range between about 5 Pa/s and about 20 Pa/s. Alternatively or additionally, the first reference differential pressure 6 may have a range between about 1 Pa/s and about 5 Pa/s. As shown in FIG. 4B, the first reference differential pressure 6 may be set to about 10 Pa/s. The first reference differential pressure 6 may be set by the user according to the magnitude of the measured pressure of the pressure gauge (e.g., pressure gauge 100 or 100A), the change pattern of the measured pressure, and/or the use method of the pressure gauge (e.g., pressure gauge 100 or 100A). However, the present disclosure is not limited by a numerical value of the first reference differential pressure 6.

As used herein, a zero point may refer to an actual measured value when the pressure gauge (e.g., pressure gauge 100 or 100A) should show a pressure value of zero (0) Pa. As used herein, a zero point error may indicate a case where the actual measured value is not zero (0) Pa even though the pressure gauge (e.g., pressure gauge 100 or 100A) should show a pressure value of zero (0) Pa. As used herein, a zero point offset may refer to a value by which the actual measured value is adjusted to zero (0) Pa when the actual measured value is not zero (0) Pa even though the pressure gauge (e.g., pressure gauge 100 or 100A) should show a pressure value of zero (0) Pa.

For example, when the generated pressure value of the pressure gauge (e.g., pressure gauge 100 or 100A) is ten (10) Pa even though the pressure gauge (e.g., pressure gauge 100 or 100A) should show a pressure value of zero (0) Pa, the zero point of the pressure gauge (e.g., pressure gauge 100 or 100A) may be ten (10) Pa, and the zero point error of the pressure gauge (e.g., pressure gauge 100 or 100A) may be ten (10) Pa. Since the zero point offset of the pressure gauge (e.g., pressure gauge 100 or 100A) is ten (10) Pa, subtracting ten (10) Pa, which is the zero point offset of the pressure gauge (e.g., pressure gauge 100 or 100A), from ten (10) Pa, which is the zero point value of the pressure gauge (e.g., pressure gauge 100 or 100A), may result in zero (0) Pa. That is, zero point calibration of the pressure gauge (e.g., pressure gauge 100 or 100A) may be performed by subtracting the generated zero point offset value of the pressure gauge (e.g., pressure gauge 100 or 100A) from the zero point value of the pressure gauge (e.g., pressure gauge 100 or 100A).

The usage-based offset slope may be generated by dividing a zero point offset difference by the first usage. The zero point offset difference may be a value obtained by subtracting a first external zero point offset value obtained after completing the zero point calibration of the first external calibration performed at the first time from a second external zero point offset value before the second external calibration. Typically, since the zero point obtained after completing the zero point calibration is measured as zero (0) Pa, the first external zero point offset value obtained after completing the zero point calibration may generally be zero (0) Pa. Therefore, the zero point offset difference may refer to a second external zero point offset. That is, the second external zero point offset generated in the second external zero point calibration process performed after the first external zero point calibration may be estimated as a zero point error generated when the pressure gauge (e.g., pressure gauge 100 or 100A) is used.

Since the unit of the zero point offset difference is pressure (e.g., Pa) and the unit of the first usage is pressure (e.g., Pa), the unit of the usage-based offset slope may be dimensionless.

After the first external zero point calibration and the second external zero point calibration are performed, a third zero point calibration may be performed. The third zero point calibration may be and/or may include the usage-based zero point calibration (operation S100) included in the pressure gauge zero point calibration method 10, according to an embodiment. In addition, the third zero point calibration may be an initial usage-based zero point calibration (operation S100).

The second zero point interval may refer to an elapsed time from the second time at which the second external zero point calibration is performed to a third time at which the third zero point calibration is performed.

A second usage, which may refer to a usage from the second time to the third time, may be generated. The process of generating the second usage may be substantially similar and/or the same as the process of generating the first usage, but unlike the first usage, the second usage may be generated from time-differential pressure records from the second time to the third time. That is, the second usage may be generated from an area of the time-differential pressure graph during the second zero point interval.

A third zero point offset may be generated by multiplying the second usage by the usage-based offset slope. In addition, usage-based zero point calibration for the pressure gauge (e.g., pressure gauge 100 or 100A) may be performed by subtracting the third zero point offset from the zero point of the pressure gauge (e.g., pressure gauge 100 or 100A) at the third time. Since the second usage is in units of pressure (e.g., Pa) and the usage-based offset slope is dimensionless, the unit of the third zero point offset obtained by multiplying the second usage by the usage-based offset slope may be pressure (e.g., Pa).

In the usage-based zero point calibration (operation S100) included in the pressure gauge zero point calibration method 10, according to an embodiment, the usage-based offset slope of the pressure gauge (e.g., pressure gauge 100 or 100A) may be obtained from two external zero point calibrations, and through the obtained usage-based offset slope thereof, the zero point calibration rather than the external zero point calibration may be performed by the pressure gauge (e.g., pressure gauge 100 or 100A) itself. Based on the time-pressure data obtained from the pressure gauge (e.g., pressure gauge 100 or 100A) continuously measuring the pressure of the equipment subject to pressure measurement over time, zero point calibration may be performed by the pressure gauge (e.g., pressure gauge 100 or 100A) itself without stopping the equipment. That is, for the zero point calibration of the pressure gauge (e.g., pressure gauge 100 or 100A), it may not be necessary to stop the equipment subject to pressure measurement by the pressure gauge (e.g., pressure gauge 100 or 100A). In addition, in the pressure gauge (e.g., pressure gauge 100 or 100A), including the diaphragm 130, zero point errors due to deposition layers attached onto the diaphragm 230 due to the fluid containing the chemical substance flowing through the conduit 113 may be effectively calibrated. Therefore, through the pressure gauge zero point calibration method 10, according to an embodiment, the measurement reliability of the pressure gauge (e.g., pressure gauge 100 or 100A) may be potentially increased, and the reliability and productivity of the equipment subject to measurement by the pressure gauge (e.g., pressure gauge 100 or 100A) may be potentially increased.

After the third zero point calibration is performed, a fourth zero point calibration may be performed. The fourth zero point calibration may be the usage-based zero point calibration (operation S100) included in the pressure gauge zero point calibration method 10, according to an embodiment. In addition, the fourth zero point calibration may be the usage-based zero point calibration performed again in operation S320 of re-performing the usage-based calibration and the observation-based calibration.

The time at which the fourth zero point calibration, which may refer to the usage-based zero point calibration performed again, is performed may be referred to as a fourth time. A third zero point interval that is a time interval from the third time to the fourth time may be generated.

During the third zero point interval, a third usage may be generated. The process of generating the third usage may be substantially similar and/or the same as the process of generating the first usage described above, but unlike the first usage, the third usage may be generated from time-differential pressure from the third time to the fourth time. That is, the third usage may be generated from an area of the time-differential pressure graph during the third zero point interval.

A fourth zero point offset may be generated by multiplying the usage-based offset slope by the third usage. The fourth zero point calibration may be performed by applying the fourth zero point offset to the pressure gauge (e.g., pressure gauge 100 or 100A) at the fourth time. That is, the fourth zero point calibration of the pressure gauge (e.g., pressure gauge 100 or 100A) may be performed by subtracting the fourth zero point offset from the zero point of the pressure gauge (e.g., pressure gauge 100 or 100A) at the fourth time when the fourth calibration is not performed.

The observation-based zero point calibration (operation S200) may include generating the observation offset (operation S210) and performing the observation-based zero point calibration using the observation offset (operation S220). As a prerequisite for observation-based zero point calibration (operation S200), the pressure applied to the pressure gauge (e.g., pressure gauge 100 or 100A) through the fluid inside the conduit 113 from the equipment should be about zero (0) Pa and may be generated without stopping the equipment.

For example, the equipment may be equipment that may repeat a specific process, and the specific process may include a series of processes consisting of a number of steps. When there is a step from among the plurality of steps in which the pressure is substantially similar and/or equal to zero (0) Pa, the observation-based zero point calibration (operation S200) may be performed. For example, in the process of checking for leakage of the equipment, the conduit 113 connected to the equipment subject to measurement by the pressure gauge (e.g., pressure gauge 100 or 100A) may be vacuumed to check for leakage. As used herein, a step in which a vacuum of the equipment is generated during a specific process performed by the equipment may be referred to as a vacuum step.

The equipment subject to the observation-based zero point calibration (operation S200) may continuously repeat the same process (and/or series of processes). In an embodiment, the process may include one or more vacuum steps. A case in which the process includes one vacuum step is described as an example. However, the present disclosure is not limited thereto, and the process may include more than one vacuum step.

The vacuum step may be continuously repeated with an approximate period as long as the equipment is continuously operated. Among a plurality of vacuum steps during operation of the equipment, two adjacent vacuum steps may include a first vacuum step and a second vacuum step. The first vacuum step and the second vacuum step are described as being two adjacent vacuum steps as an example. However, the present disclosure is not limited thereto, and the two vacuum steps do not necessarily have to be adjacent to each other. Therefore, a first elapsed time between steps and a second elapsed time between steps, as described below, may not necessarily be elapsed times between adjacent vacuum steps. For example, vacuum steps including the first vacuum step and the second vacuum step may be a multiple of a repeated time period. As another example, the first elapsed time between steps may be twice the time period during which the vacuum step is repeated.

In an embodiment, the first vacuum step and the second vacuum step may be steps in which the vacuum is generated in the equipment during a specific process performed by the equipment. However, in the first vacuum step and the second vacuum step, a pressure value other than zero (0) Pa may be measured due to a zero point error of the pressure gauge (e.g., pressure gauge 100 or 100A). The observation-based zero point calibration (operation S200) may include calibrating the zero point error thereof.

The first elapsed time between steps, which may refer to an elapsed time from the first vacuum step to the second vacuum step, may be generated. A pressure value measured by the pressure gauge (e.g., pressure gauge 100 or 100A) in the second vacuum step may be referred to as a second step pressure, and a pressure value measured by the pressure gauge (e.g., pressure gauge 100 or 100A) at the first vacuum step may be referred to as a first step pressure. In an embodiment, the first step pressure and the second step pressure may be measured as zero (0) Pa, which may be substantially similar and/or the same as the actual pressure. Alternatively, the first step pressure and the second step pressure may be measured as a value other than zero (0) Pa.

The pressure difference between steps may be obtained by subtracting the first step pressure of the first vacuum step in which zero point calibration is performed from the second step pressure of the second vacuum step in which zero point calibration is not performed. The first step pressure of the first vacuum step in which zero point calibration is performed may be measured as zero (0) Pa. Therefore, when zero point calibration is performed in the first vacuum step, the first pressure difference between steps may be equal to the second step pressure of the second vacuum step. When zero point calibration is not performed in the first vacuum step, a value obtained by subtracting the first step pressure from the second step pressure may be the first pressure difference between steps.

The first observation-based offset slope may refer to a value obtained by dividing the first pressure difference between steps by the first elapsed time between steps. When zero point calibration is performed in the first vacuum step, the first pressure difference between steps may be equal to the second step pressure. That is, when zero point calibration is not performed in the first vacuum step, the first observation-based offset slope may be a value obtained by dividing the second step pressure by the first elapsed time between steps. The first observation-based offset slope may be in units of pressure/time (e.g., Pa/s).

The first estimated offset slope may be generated through the first observation-based offset slope. When there is an observation-based offset slope preceding the first observation-based offset slope, the first estimated offset slope may be generated through the preceding observation-based offset slope and the first observation-based offset slope. Repeated observation-based zero point calibration is described below.

The first estimated offset slope may be generated by multiplying the first observation-based offset slope by a value obtained by subtracting a first coefficient α from 1 (e.g., 1−α). The first observation-based offset slope is multiplied by 1−α to conservatively perform observation-based zero point calibration, thereby potentially reducing cases where zero point errors occur due to zero point calibration.

A first observation offset may be generated by multiplying the generated first estimated offset slope by the first elapsed time between steps. The observation-based zero point calibration in the second vacuum step may be completed by subtracting the first observation offset from the second step pressure.

Operation S310 of repeatedly performing observation-based zero point calibration for the pressure gauge (e.g., pressure gauge 100 or 100A) may be performed. After the second vacuum step, the observation-based zero point calibration may be performed for a third vacuum step.

The second elapsed time between steps, which may refer to an elapsed time from the second vacuum step to the third vacuum step, may be generated. The second pressure difference between steps may be generated by subtracting the second step pressure of the second vacuum step for which the observation-based zero point calibration is performed from a third step pressure of the third vacuum step.

A second observation-based offset slope may be generated by dividing the second pressure difference between steps by the second elapsed time between steps. A second estimated offset slope may be generated from the second observation-based offset slope and the first estimated offset slope.

The second estimated offset slope may be generated by adding a value obtained by multiplying the first coefficient α by the first estimated offset slope and a value obtained by multiplying 1−α by the second observation-based offset slope. The first coefficient α may be a real number greater than zero (0) and less than about one (1). For example, the first coefficient α may be a real value greater than or equal to about 0.7. As another example, the first coefficient α may be a real number less than or equal to about 0.9.

The second observation offset may be generated by multiplying the second estimated offset slope by the second elapsed time between steps. Repeated observation-based zero point calibration for the third vacuum step may be performed by subtracting the second observation offset from the third step pressure before zero point calibration.

However, a criterion may be needed for the zero point controller 160 to identify a plurality of vacuum steps including the first vacuum step, the second vacuum step, and the third vacuum step. For example, conditions for identifying the vacuum steps may include a first pressure condition and a second time condition.

In an embodiment, the first pressure condition may be satisfied when the pressure of the vacuum step is within a certain numerical range based on the minimum pressure. Since the minimum pressure of the vacuum step may typically be substantially similar or equal to zero (0) Pa, the first pressure condition may be satisfied when the pressure of the vacuum step is within a certain numerical range based on zero (0) Pa.

In an embodiment, for the third vacuum step, the first pressure condition may be satisfied when the third step pressure is included within a range from a value obtained by multiplying the first observation offset by a second coefficient β and negative one (1) (e.g., −1×β) to a value obtained by multiplying the first observation offset by the second coefficient β and positive one (1) (e.g., +1×β). For the third vacuum step, the second time condition may be satisfied when the third vacuum step is greater than a third constant T.

In an embodiment, the second coefficient β may be a value greater than about 1 and less than about 1.4. For example, the second coefficient β may be equal to about 1.1. The third constant T may be a value that may vary depending on the vacuum step of the equipment that is subject to pressure measurement by the pressure gauge (e.g., pressure gauge 100 or 100A). For example, the third constant T may be between about 20 seconds and about 40 seconds. However, the present disclosure is not limited to the numerical example of the third constant T.

In an embodiment, the usage-based zero point calibration (operation S100) may be repeated, and the observation-based zero point calibration (operation S200) may also be repeated. However, there may be a difference between the period in which the usage-based zero point calibration (operation S100) is repeated and the period in which observation-based zero point calibration (operation S200) is repeated. For example, the period during which the observation-based zero point calibration (operation S200) is repeated may be between about 1 minute and about 60 minutes, and the period over which the usage-based zero point calibration (operation S100) is repeated may be between about 1 day and about 120 days. Numerical examples of the period in which the usage-based zero point calibration (operation S100) is repeated and numerical examples of the period in which the observation-based zero point calibration (operation S200) is repeated are provided to aid understanding of the present disclosure. However, the present disclosure is not limited by the numerical examples of the period.

Although the usage-based zero point calibration is performed twice as an example, the usage-based zero point calibration may be performed repeatedly during the measurement of the pressure gauge (e.g., pressure gauge 100 or 100A), and the process of repeatedly performing usage-based zero-point calibration may be understood through the description of the above-described usage-based zero-point calibration (operation S100) being performed twice. Accordingly, a person skilled in the art may understand that the method of repeatedly performing the usage-based zero point calibration may include performing the usage-based zero point calibration more than two times.

Similarly, although the observation-based zero point calibration is performed twice as an example, the observation-based zero point calibration may be continuously performed during the measurement of the pressure gauge (e.g., pressure gauge 100 or 100A), and the process of repeatedly performing the observation-based zero point calibration may be understood through the description of the above-described observation-based zero point calibration (operation S200) being performed twice. Therefore, a person skilled in the art may understand the operation S310 of repeatedly performing the observation-based zero point calibration. In addition, a person skilled in the art may understand the operation S320 of re-performing the usage-based zero point calibration and the observation-based zero point calibration.

Due to differences in repeating periods, the observation-based zero point calibration (operation S200) may be continuously performed, and the usage-based zero point calibration (operation S100) may be performed while multiple observation-based zero point calibrations (operation S200) are being performed. Since the above description may be substantially similar and/or the same as the repeated usage-based zero point calibration, detailed description thereof may be omitted for the sake of brevity.

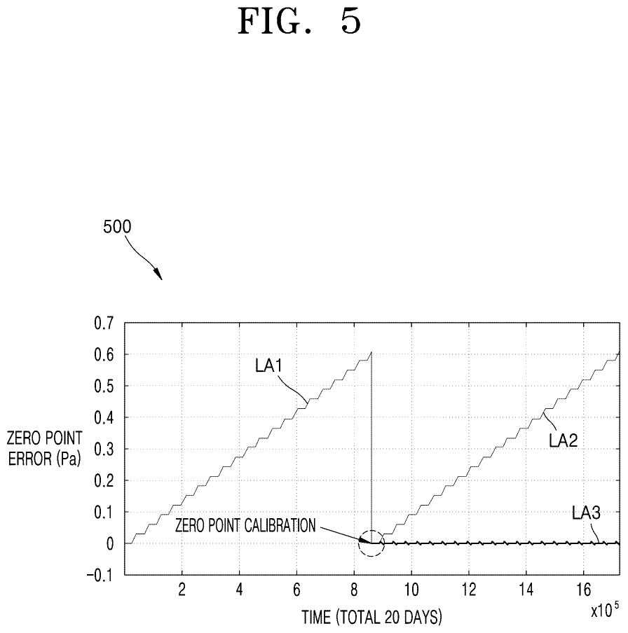

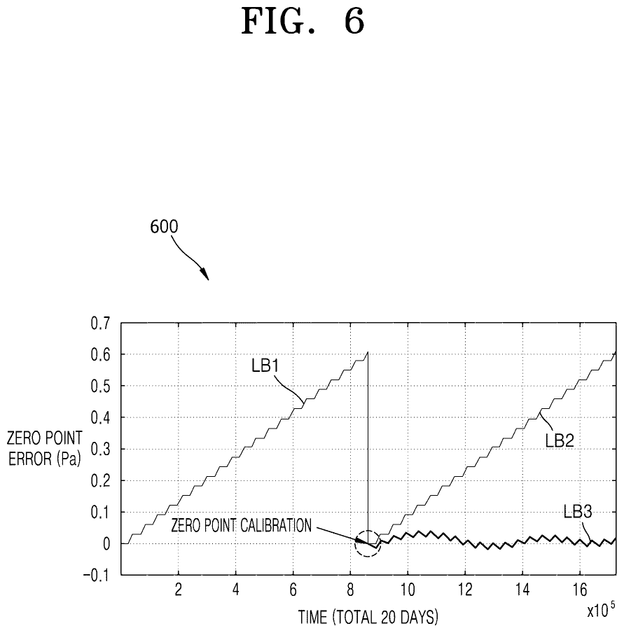

FIGS. 5 and 6 are graphs showing zero point errors depending on whether the pressure gauge zero point calibration method 10 is applied, according to an embodiment. Descriptions that may be substantially similar and/or the same as those given above may be omitted.

The horizontal axis in graph 500 of FIG. 5 and the horizontal axis in graph 600 of FIG. 6 represent a time during for a total of 20 days. The vertical axes of graphs 500 and 600 in FIGS. 5 and 6 represent a zero point error in units of pressure (e.g., Pa). FIGS. 5 and 6 are graphs showing the results of simulating the zero point error when operating the equipment for 20 days depending on whether the zero point calibration is performed.

Referring to FIG. 5, a first line LA1 is a case where a zero point calibration is not performed, and a second line LA2 is a case where a general zero point calibration is performed once. As shown in FIG. 5, the second line LA2 has a similar shape to that of the first line LA1. A third line LA3 is a case where the usage-based zero point calibration S100 and the observation-based zero point calibration S200 are continuously repeatedly performed from the time when the zero point calibration is started, indicated by the dashed line.

Referring to FIG. 6, a first line LB1 is a case where a zero point calibration is not performed, and a second line LB2 is a case where a general zero point calibration is performed once. As shown in FIG. 5, the second line LB2 has a similar shape to that of the first line LB1. A third line LB3 is a case where the usage-based zero point calibration (operation S100) is not performed from the time when the zero point calibration is started, indicated by the dashed line, and only the observation-based zero point calibration (operation S200) is continuously repeatedly performed.

Comparing FIG. 5 with FIG. 6, in the third line LB3 of FIG. 6, which is a case where the observation-based zero point calibration (operation S200) is continuously performed, the zero point error is maintained with a slight fluctuation in the value based on zero (0) Pa. In the third line LA3 of FIG. 5, which is a case where the usage-based zero point calibration (operation S100) and the observation-based zero point calibration (operation S200) are continuously repeatedly performed, the zero point error rarely occurs based on zero (0) Pa. That is, the zero point calibration of the pressure gauge may be performed by itself only using the observation-based zero point calibration (operation S200). In addition, when usage-based zero point calibration (operation S100) is applied together with the observation-based zero point calibration (operation S200), a relatively more accurate zero point calibration of the pressure gauge may be achieved by itself.

While the present disclosure has been particularly shown and described with reference to embodiments thereof, it is to be understood that various changes in form and details may be made therein without departing from the spirit and scope of the following claims.

What is claimed is:

1. A pressure gauge zero point calibration method of a pressure gauge, the pressure gauge zero point calibration method comprising:
performing a first external zero point calibration at a first time;
performing a second external zero point calibration at a second time, the second time occurring after the first time;
generating a first usage during a first zero point interval, the first zero point interval spanning from the first time to the second time;
determining a usage-based offset slope by dividing a zero point offset difference by the first usage;
generating a second usage during a second zero point interval, the second zero point interval spanning from the second time to a third time, the third time occurring after the second time;
obtaining a third zero point offset based on the usage-based offset slope and the second usage; and
applying the third zero point offset to the pressure gauge, the pressure gauge having a diaphragm,
wherein the first usage comprises a first area of a time versus differential pressure graph during the first zero point interval,
wherein the second usage comprises a second area of the time versus differential pressure graph during the second zero point interval, and
wherein the zero point offset difference is obtained by subtracting a first external zero point offset after completing the performing of the first external zero point calibration from a second external zero point offset prior to the performing of the second external zero point calibration.

2. The pressure gauge zero point calibration method of claim 1, further comprising:
obtaining the third zero point offset by multiplying the usage-based offset slope by the second usage.

3. The pressure gauge zero point calibration method of claim 2, wherein the first usage comprises the first area of the time versus differential pressure graph during the first zero point interval that exceeds a first reference differential pressure, and
wherein the second usage comprises the second area of the time versus differential pressure graph during the second zero point interval that exceeds the first reference differential pressure.

4. The pressure gauge zero point calibration method of claim 3, wherein the first reference differential pressure has a range between 5 Pascals per second (Pa/s) and 20 Pa/s.

5. The pressure gauge zero point calibration method of claim 1, further comprising:
generating a third usage during a third zero point interval the third zero point interval spanning from the third time to a fourth time, the fourth time occurring after the third time;
generating a fourth zero point offset based on the usage-based offset slope and the third usage; and
applying the fourth zero point offset to the pressure gauge,
wherein the third usage comprises a third area of the time versus differential pressure graph during the third zero point interval, and
wherein the fourth zero point offset is obtained by multiplying the usage-based offset slope by the third usage.

6. The pressure gauge zero point calibration method of claim 5, wherein the third zero point interval has a range between 1 day and 120 days.

7. The pressure gauge zero point calibration method of claim 1, further comprising:
generating a first observation-based offset slope by dividing a first pressure difference between steps by a first elapsed time between the steps;
determining a first estimated offset slope based on the first observation-based offset slope;
obtaining a first observation offset based on the first estimated offset slope and the first elapsed time between the steps; and
applying the first observation offset to the pressure gauge,
wherein the first pressure difference between the steps is obtained by subtracting a first step pressure of a first vacuum step in which a zero point calibration is performed from a second step pressure of a second vacuum step in which the zero point calibration is not performed, and
wherein the first elapsed time between the steps is a first time duration from the first vacuum step to the second vacuum step.

8. The pressure gauge zero point calibration method of claim 7, further comprising:
obtaining the first estimated offset slope by multiplying the first observation-based offset slope by a value obtained by subtracting a first coefficient from 1,
wherein the first coefficient is a real number having a range between 0.7 and 1.

9. The pressure gauge zero point calibration method of claim 7, wherein the first elapsed time between the steps is a multiple of a time period in which a plurality of vacuum steps comprising the first vacuum step and the second vacuum step are repeated.

10. The pressure gauge zero point calibration method of claim 7, further comprising:
generating a second observation-based offset slope by dividing a second pressure difference between the steps by a second elapsed time between the steps;
determining a second estimated offset slope based on the first estimated offset slope and the second observation-based offset slope;
obtaining a second observation offset based on the second estimated offset slope and the second elapsed time between the steps; and
applying the second observation offset to the pressure gauge,
wherein the second pressure difference between the steps is obtained by subtracting a third step pressure of a third vacuum step in which the zero point calibration is performed from a fourth step pressure of a fourth vacuum step in which the zero point calibration is not performed, and
wherein the second elapsed time between the steps is a second time duration from the third vacuum step to the fourth vacuum step.

11. The pressure gauge zero point calibration method of claim 10, further comprising:
obtaining the second estimated offset slope by adding a first value obtained by multiplying the first estimated offset slope by a first coefficient and a second value obtained by multiplying the second observation-based offset slope by a difference of 1 and the first coefficient,
wherein the first coefficient is a real number between 0.7 and 1.

12. The pressure gauge zero point calibration method of claim 11, wherein the fourth vacuum step satisfies a first pressure condition and a second time condition,
wherein the first pressure condition is satisfied based on the fourth step pressure being between a first limit obtained by multiplying the first observation offset by a second coefficient and −1 and a second limit obtained by multiplying the first observation offset by the second coefficient and +1, and
wherein the second time condition is satisfied based on the time of the fourth vacuum step being greater than a third time constant.

13. The pressure gauge zero point calibration method of claim 10, further comprising:
generating a third usage during a third zero point interval, the third zero point interval spanning from the third time to a fourth time; and
determining a fourth zero point offset based on the usage-based offset slope and the third usage;
wherein the third usage comprises a third area of the time versus differential pressure graph during the third zero point interval, and
wherein the fourth zero point offset is obtained by multiplying the usage-based offset slope by the third usage.

14. The pressure gauge zero point calibration method of claim 13, wherein the second zero point interval and the third zero point interval have a range between 1 day and 120 days, and
wherein the first elapsed time between the steps and the second elapsed time between the steps have a range between 1 minute and 60 minutes.

15. A pressure gauge zero point calibration method of a pressure gauge, the pressure gauge zero point calibration method comprising:
performing a first external zero point calibration at a first time;
performing a second external zero point calibration at a second time, the second time occurring after the first time;
generating a first observation-based offset slope by dividing a first pressure difference between steps by a first elapsed time between the steps;
determining a first estimated offset slope based on the first observation-based offset slope;
obtaining a first observation offset based on the first estimated offset slope and the first elapsed time between the steps; and
applying the first observation offset to the pressure gauge, the pressure gauge having a diaphragm,
wherein the first pressure difference between the steps is obtained by subtracting a first step pressure of a first vacuum step in which a zero point calibration is performed from a second step pressure of a second vacuum step in which the zero point calibration is not performed, and
wherein the first elapsed time between the steps is a first time duration from the first vacuum step to the second vacuum step.

16. The pressure gauge zero point calibration method of claim 15, further comprising:
generating a first usage during a first zero point interval, the first zero point interval spanning from the first time to the second time;
determining a usage-based offset slope by dividing a zero point offset difference by the first usage;
generating a second usage during a second zero point interval, the second zero point interval spanning from the second time to a third time;
determining a third zero point offset based on the usage-based offset slope and the second usage; and
applying the third zero point offset to the pressure gauge,
wherein the first usage comprises a first area of a time versus differential pressure graph exceeding a first reference differential pressure during the first zero point interval,
wherein the second usage comprises a second area of the time versus differential pressure graph exceeding the first reference differential pressure during the second zero point interval,
wherein the zero point offset difference is obtained by subtracting a first external zero point offset of the first external zero point calibration from a second external zero point offset of the second external zero point calibration, and
wherein the third zero point offset is obtained by multiplying the usage-based offset slope by the second usage.

17. The pressure gauge zero point calibration method of claim 16, further comprising:
generating a second observation-based offset slope by dividing a second pressure difference between the steps by a second elapsed time between the steps;
determining a second estimated offset slope based on the first estimated offset slope and the second observation-based offset slope;
obtaining a second observation offset based on the second estimated offset slope and the second elapsed time between the steps; and
applying the second observation offset to the pressure gauge,
wherein the second pressure difference between the steps is obtained by subtracting a third step pressure of a third vacuum step in which the zero point calibration is performed from a fourth step pressure of a fourth vacuum step in which the zero point calibration is not performed,
wherein the second elapsed time between the steps is a second time duration from the second vacuum step to the third vacuum step,
wherein the second estimated offset slope is a sum of a first value obtained by multiplying the usage-based offset slope by a first coefficient and a second value obtained by multiplying the second observation-based offset slope by a difference of 1 and the first coefficient, and
wherein the first coefficient is a real number between 0.7 and 1.

18. The pressure gauge zero point calibration method of claim 17, further comprising:
generating a third usage during a third zero point interval, the third zero point interval spanning from the third time to a fourth time, the fourth time occurring after the third time; and
determining a fourth zero point offset based on the usage-based offset slope and the third usage,
wherein the third usage comprises a third area of the time versus differential pressure graph during the third zero point interval, and
wherein the fourth zero point offset is obtained by multiplying the usage-based offset slope by the third usage.

19. A pressure gauge zero point calibration method of a pressure gauge, the pressure gauge zero point calibration method comprising:
performing a first external zero point calibration at a first time;
performing a second external zero point calibration at a second time, the second time occurring after the first time;
generating a first usage during a first zero point interval, the first zero point interval spanning from the first time to the second time;
determining a usage-based offset slope by dividing a zero point offset difference by the first usage;
generating a second usage during a second zero point interval, the second zero point interval spanning from the second time to a third time, the third time occurring after the second time;
determining a third zero point offset based on the usage-based offset slope and the second usage;
applying the third zero point offset to the pressure gauge, the pressure gauge having a diaphragm;
obtaining a first observation-based offset slope by dividing a first pressure difference between steps by a first elapsed time between the steps;
generating a first estimated offset slope based on the first observation-based offset slope;
generating a first observation offset based on the first estimated offset slope and the first elapsed time between the steps;
applying the first observation offset to the pressure gauge;
generating a second observation-based offset slope by dividing a second pressure difference between the steps by a second elapsed time between the steps;
generating a second estimated offset slope based on the first estimated offset slope and the second observation-based offset slope;
generating a second observation offset based on the second estimated offset slope and the second elapsed time between the steps;
applying the second observation offset to the pressure gauge;
generating a third usage during a third zero point interval, the third zero point interval spanning from the third time to a fourth time; and
generating a fourth zero point offset based on the usage-based offset slope and the third usage,
wherein the first usage comprises a first area of a time versus differential pressure graph exceeding a first reference differential pressure during the first zero point interval,
wherein the second usage comprises a second area of the time versus differential pressure graph exceeding the first reference differential pressure during the second zero point interval,
wherein the third usage comprises a third area of the time versus differential pressure graph exceeding the first reference differential pressure during the third zero point interval,
wherein the zero point offset difference is obtained by subtracting a first external zero point offset of the first external zero point calibration from a second external zero point offset of the second external zero point calibration,
wherein the third zero point offset is obtained by multiplying the usage-based offset slope by the second usage,
wherein the fourth zero point offset is obtained by multiplying the usage-based offset slope by the third usage,
wherein the first pressure difference between the steps is obtained by subtracting a first step pressure of a first vacuum step in which a zero point calibration is performed from a second step pressure of a second vacuum step in which the zero point calibration is not performed,
wherein the second pressure difference between the steps is obtained by subtracting a third step pressure of a third vacuum step in which the zero point calibration is performed from a fourth step pressure of a fourth vacuum step in which the zero point calibration is not performed,
wherein the first elapsed time between the steps is a first time duration from the first vacuum step to the second vacuum step,
wherein the second elapsed time between the steps is a second time duration from the second vacuum step to the third vacuum step,
wherein the second zero point interval and the third zero point interval have a range between 1 day and 120 days,
wherein the first elapsed time between the steps and the second elapsed time between the steps have a range between 1 minute and 60 minutes, and
wherein the first reference differential pressure has a range between 5 Pascals per second (Pa/s) and 20 Pa/s.

20. The pressure gauge zero point calibration method of claim 19, wherein the fourth vacuum step satisfies a first pressure condition and a second time condition,
wherein the first pressure condition is satisfied based on the fourth step pressure being between a first limit obtained by multiplying the first observation offset by a second coefficient and −1 and a second limit obtained by multiplying the first observation offset by the second coefficient and +1, and
wherein the second time condition is satisfied based on the time of the fourth vacuum step being greater than a third time constant.
